(19) United States
(12) Patent Application Publication
(10) Pub. No.: US 2020/0260190 A1
(43) Pub. Date: Aug. 13, 2020

(54) SOUND VIBRATION ACTUATOR

(71) Applicant: Mplus CO., LTD., Suwon-si (KR)

(72) Inventors: Seok Jun PARK, Suwon-si (KR); Jun Kun CHOI, Suwon-si (KR); Yeon Ho SON, Suwon-si (KR); Yong Tae KIM, Suwon-si (KR); Yong Jin KIM, Suwon-si (KR); Seung Wook KIM, Suwon-si (KR); Dong Su MOON, Suwon-si (KR)

(21) Appl. No.: 16/708,885

(22) Filed: Dec. 10, 2019

(30) Foreign Application Priority Data
Feb. 7, 2019 (KR) 10-2019-0014464

(51) Int. Cl. H04R 9/06; H04R 9/02; H04R 1/02

(52) U.S. Cl. CPC H04R 9/06; H04R 7/12; H04R 1/025; H04R 9/025

(57) ABSTRACT

A sound vibration actuator includes a casing having an internal space formed by an underside casing part, a side periphery casing part, and a top casing part, a coil part coupled to the top casing part in such a manner as to receive power from the outside, a magnet part disposed in the internal space of the casing, an elastic member whose one surface coupled to the magnet part, and a weight part coupled to the top casing part. The sound vibration actuator is configured to allow the weight part to be coupled to the part for generating vibrations, thereby controlling vibrations in a high frequency resonance band.

### CROSS REFERENCE TO RELATED APPLICATION

The present application claims the benefit of Korean Patent Application No. 10-2019-0014464 filed in the Korean Intellectual Property Office on Feb. 7, 2019, the entire content of which is incorporated herein by reference.

### BACKGROUND OF THE INVENTION

### 1. Field of the Invention

The present invention relates to a sound vibration actuator, and more particularly, to a sound vibration actuator that is capable of generating and controlling vibrations in a high frequency band.

### 2. Description of Related Art

Generally, mobile terminals like smartphones have vibration functions (haptic functions) of interfacing call forwarding as well as of interfacing key input, event occurrence, and application execution to a user.) A vibration motor converting an electromagnetic force into a mechanical driving force is used as a driving device to generate up and down vibrations.

Meanwhile, as a mobile terminal has had a bezel-less design that has a screen-to-body ratio higher than 90%, recently, there are suggested new technologies wherein a sound speaker, receiver hole, and so on, which are disposed on a front surface of the mobile terminal in a conventional practice, are located inside the mobile terminal. As a result, there is developed a sound vibration actuator as one of such new technologies that controls a frequency of a vibration motor using an electromagnetic force to generate a desired sound.

So as to perform a sound function in a mobile terminal, particularly, the sound vibration actuator needs a technology capable of controlling both of vibrations having a high resonance frequency for generating high frequency sounds and vibrations in a high frequency band.

Accordingly, there is a need for development of a sound vibration actuator capable of generating a resonance frequency in various frequency bands to provide sound functions of a speaker, receiver, and so on.

### SUMMARY OF THE INVENTION

Accordingly, the present invention has been made in view of the above-mentioned problems occurring in the related art, and it is an object of the present invention to provide a sound vibration actuator that is capable of controlling a resonance frequency.

It is another object of the present invention to provide a sound vibration actuator that is capable of controlling a frequency in a high frequency band.

It is yet another object of the present invention to provide a sound vibration actuator that is capable of being mounted on an external sound generation device to function as both of a vibration generation device and a sound generation device.

The technical problems to be achieved through the present invention are not limited as mentioned above, and other technical problems not mentioned herein will be obviously understood by one of ordinary skill in the art through the following description.

To accomplish the above-mentioned objects, according to the present invention, there is provided a sound vibration actuator including: a casing having an internal space formed by an underside casing part, a side periphery casing part, and a top casing part, a coil part coupled to the top casing part in such a manner as to receive power from the outside, a magnet part disposed in the internal space of the casing, an elastic member whose one surface coupled to the magnet part, and a weight part coupled to the top casing part.

According to the present invention, desirably, the weight part is coupled to top of the top casing part.

According to the present invention, desirably, the underside casing part is fixed to an external sound generator.

According to the present invention, desirably, the top casing part has a protrusion protruding from a center thereof.

According to the present invention, desirably, the protrusion has a hollow shape in such a manner as to protrude inward from top of the top casing part.

According to the present invention, the weight part comprises: a first area coming into contact with a center area of the top casing part where the protrusion is formed, and a second area spaced apart from the entire area of the top casing part except the first area by the given distance.

According to the present invention, desirably, a thickness of the first area is higher than a thickness of the second area.

According to the present invention, the weight part further comprises a shaft extended from the first area in such a manner as to be disposed inside the protrusion having the hollow shape.

According to the present invention, desirably, the weight part is penetrated into a center portion thereof in such a manner as to have a shape a ring and further comprises a shaft insertedly fitted to the center portion thereof.

According to the present invention, desirably, the weight part is made of a material having a higher specific gravity than the coil part and the top casing part.

### BRIEF DESCRIPTION OF THE DRAWINGS

The above and other objects, features and advantages of the present invention will be apparent from the following detailed description of the embodiments of the invention in conjunction with the accompanying drawings, in which:

FIG. 1 is a perspective view showing a sound vibration actuator according to first to fifth embodiments of the present invention;

FIGS. 2 to 3 are sectional views taken along the line A-A′ of the sound vibration actuator according to the first and the second embodiments of the present invention in FIG. 1;

FIG. 4 is a sectional view taken along the line A-A′ of the sound vibration actuator according to the third embodiment of the present invention in FIG. 1;

FIG. 5 is sectional views taken along the line A-A′ of the sound vibration actuator according to the fourth and fifth embodiments of the present invention in FIG. 1; and

FIG. 6 is graphs showing changes in the characteristics of the sound vibration actuator according to the first embodiment of the present invention.

### DETAILED DESCRIPTION OF THE EMBODIMENTS

Hereinafter, the present invention will be explained in detail with reference to the attached drawings. In the description, it should be noted that the parts corresponding to those of the drawings are indicated by corresponding reference numerals. Objects, characteristics and advantages of the present invention will be more clearly understood from the detailed description as will be described below and the attached drawings. Before the present invention is disclosed and described, it is to be understood that the disclosed embodiments are merely exemplary of the invention, which can be embodied in various forms.

All terms (including technical or scientific terms) used herein, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification. An expression referencing a singular value additionally refers to a corresponding expression of the plural number, unless explicitly limited otherwise by the context.

In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

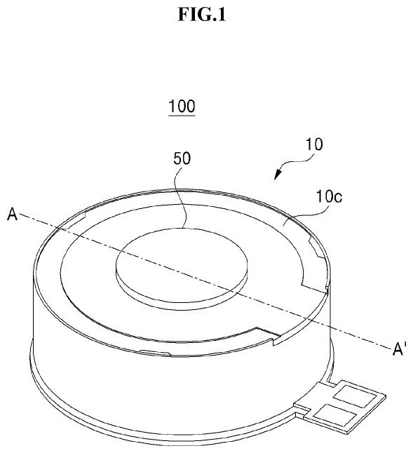

FIG. 1 is a perspective view showing a sound vibration actuator according to first to fifth embodiments of the present invention.

Before the present invention is described with reference to FIG. 1, first, the sound vibration actuator 100 according to the present invention is a device that generates vibrations and sounds produced by the vibrations. In detail, the sound vibration actuator 100 is adapted to generate vibrations through electromagnetic forces of internal components and is also adapted to allow at least one surface thereof to be coupled to an external sound generator S to generate sounds produced by the vibrations.

As shown in FIG. 1, the sound vibration actuator 100 has a shape of a flat cylinder and is configured to have an input terminal (having no reference numeral) exposed from a bottom periphery thereof to supply power thereto. In this case, the input terminal is a power supply terminal drawn from an interior of the sound vibration actuator 100 to the outside, and it may be formed of a flexible printed circuit (FPC).

So as to allow the input terminal to be seated onto the sound vibration actuator 100, a board seating part (having no reference numeral) is extended outward from the bottom surface of the sound vibration actuator 100, and otherwise, the underside casing part 10a protrudes outward from a given outer peripheral surface thereof.

As shown in FIG. 1, the input terminal is located on the bottom of the sound vibration actuator 100, but without being limited thereto, of course, the input terminal may be bent upward to supply power to the top side of the internal space of the sound vibration actuator 100.

The sound vibration actuator 100 according to the first embodiment of the present invention further includes a weight part 50 mounted on the top casing part 10c disposed on a top side of the casing 10 constituting an outer shape thereof. In this case, the weight part 50 serves to improve vibration characteristics of the sound vibration actuator 100. A detailed explanation on the weight part 50 will be discussed later.

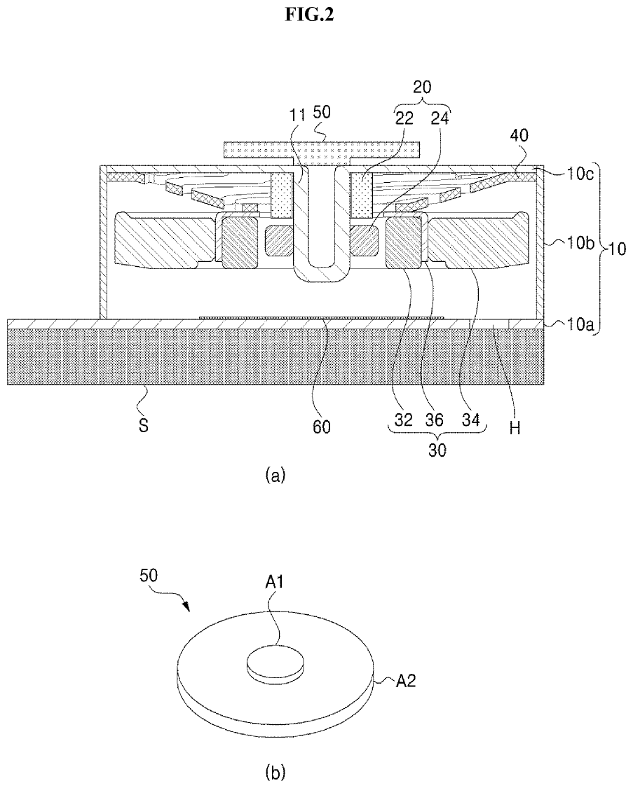

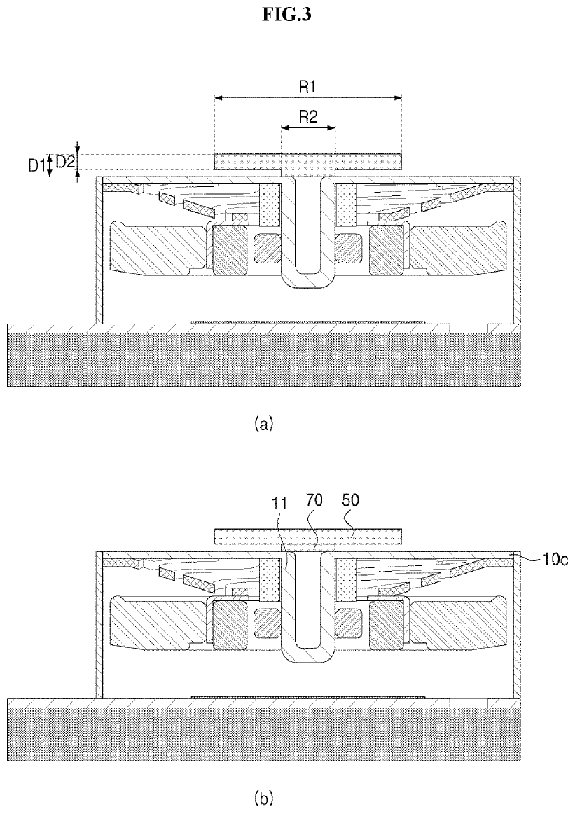

FIGS. 2 to 3 are sectional views taken along the line A-A′ of the sound vibration actuator according to the first and the second embodiments of the present invention in FIG. 1.

As shown in (a) of FIG. 2, the sound vibration actuator 100 includes a casing 10, a coil part 20, a magnet part 30, an elastic member 40 and a weight part 50.

First, the casing 10 has a space formed therein to accommodate the casing 10, the coil part 20, the magnet part 30, the elastic member 40 and the weight part 50 therein.

The casing 10 is constituted of an underside casing part 10a, a side periphery casing part 10b, and a top casing part 10c that are coupled to each other by means of caulking, bonding or welding.

The top casing part 10c has a protrusion 11 formed at the center thereof so as to seat the coil part 20 thereonto. The protrusion 11, which has a hollow shape protruding inward from the center of the top casing part 10c, can be very easily formed by means of press or deep drawing. If the protrusion 11 has such a hollow shape, advantageously, manufacturing and coupling processes can be simple, a weight of the sound vibration actuator 100 can be reduced, a variety of magnetic materials can be inserted later into the hollow portion of the protrusion 11 from the outside to adjust the amount of magnetic flux.

On the other hand, the weight part 50 is coupled to the top casing part 10c to control a resonance frequency in a high frequency band in the sound vibration actuator 100. In detail, if the weight part 50 coupled to the top casing part 10c has a higher specific gravity than the coil part 20 coupled to the top casing part 10c or the protrusion 11, a high frequency resonance band generated by the vibration of the coil part 20 can be lower than that when not coupled to the weight part 50.

The top casing part 10c may be an acoustic diaphragm, and accordingly, the coil part 20 is vibrated by an electromagnetic force generated between the magnet part 30 and itself, thereby generating sounds.

The side periphery casing part 10b is provided to the same shape as the outer peripheries of the top casing part 10c and the underside casing part 10a. According to the present invention, the side periphery casing part 10b has a shape of a cylinder, but without being limited thereto, of course, it may have a sectional shape of a square or polygon according to shapes of the top casing part 10c and the underside casing part 10a. Also, the elastic member 40 disposed in the internal space of the casing 10 has the same sectional shape as the square or polygonal side periphery casing part 10b.

The underside casing part 10a can be fixed to the external sound generator S. To do this, the underside casing part 10a has an adhesive member disposed on one surface thereof, and otherwise, it has fixing holes (not shown) punched thereon. The external sound generator S includes various kinds of mechanisms for generating sounds, for example, a display module.

Only the underside casing part 10a is fixed to the external sound generator S, and other parts are not fixed to any external devices, so that if power is supplied to the sound vibration actuator 100, the coil part 20 disposed at the inner surface of the top casing part 10c and the weight part 50 disposed at the outer surface of the top casing part 10c are vibrated together to allow the external sound generator s connected to the sound vibration actuator 100 to generate vibrations in the range of a high frequency band. In more detail, if the coil part 20 vibrates, vibrations with a high center resonance frequency of 5000 Hz as well as with a low center resonance frequency of 100 Hz can be generated.

Further, the casing 10 having the underside casing part 10a, the side periphery casing part 10b, and the top casing part 10c is made of a magnetic material so as to optimize a magnetic field generated from the coil part 20 and the magnet part 30 disposed therein. Accordingly, the underside casing part 10a, the side periphery casing part 10b, and the top casing part 10c are made of the same magnetic material as each other, and otherwise, they may be made of different magnetic materials from each other according to a user's selection.

Next, the coil part 20 has a coil 22 and a coil yoke 24. In this case, the coil 22 and the coil yoke 24 are coupled to top of the casing 10, that is, the top casing part 10c, and since only the outer periphery of the top casing part 10c is fixed to the side periphery casing part 10b, the remaining region thereof is not fixed to any component, so that in a process where the coil 22 and the coil yoke 24 are vibrated, the top casing part 10c can be vibrated together.

Meanwhile, the coil 22 of the coil part 20 may be a sound coil that generates magnetic fields having different directions and strengths. In more detail, if an alternating current is applied to the coil 22, an alternating magnetic field is generated from the coil 22, so that the top casing part 10c coming into contact with the coil 22 is vibrated to a signal in an audible frequency range, thereby generating sounds.

The coil 22 and the coil yoke 24 of the coil part 20 are fitted to the protrusion 11 of the top casing part 10c, and the coil 22 is disposed on top of the coil yoke 24. Also, the coil 22 and the coil yoke 24 have a shape of a ring, but without being limited thereto, of course, they may have various shapes fitted to the protrusions 11.

The coil yoke 24 of the coil part 20 is fittedly disposed on the outer peripheral surface of the protrusion 11 in parallel with the coil 22, is made of a magnetic material, and serves to amplify the electromagnetic force generated from the coil 22.

In the process where the coil part 20 is vibrated according to an electromagnetic force generated from the coil 22 and the coil yoke 24, if the electromagnetic force corresponding to a resonance frequency of the magnet part 30 disposed parallel to the coil part 20 is generated, the magnet part 30 can be operated. Accordingly, if it is designed that the magnet part 30 has the resonance frequency in the range of 100 to 300 Hz, an alternating current corresponding to the resonance frequency is supplied to the coil part 20, so that the magnet part 30 can be operated. Of course, the resonance frequency band of the magnet part 30 can be changed according to design conditions thereof.

The magnet part 30 is located around the coil 22 and includes a magnet 32, a weight 34, and a yoke 36. If the alternating current is applied to the coil 22 of the coil part 20, the magnet part 30 can be operated differently in variance with the magnitude of the alternating current.

The magnet 32 of the magnet part 30 is disposed around the coil yoke 24 and can vibrates up and down cooperating with the alternating magnetic field generated from the coil 22. Though the magnet 32 is one in (a) of FIG. 2, it may include two or more magnets coupled to each other. If the two or more magnets are coupled to each other, the electromagnetic force can be stronger than that generated from one magnet.

Meanwhile, a magnetic fluid (not shown) can be applied to one of the side surfaces of the magnet 32 or the coil yokes 24 to prevent direct contact between them, thereby suppressing the noise or damage caused by direct collision between them. Further, because of its viscosity, the magnetic fluid can help the magnet 32 stop vibration more quickly after turning off the power.

The weight 34 of the magnet part 30 is disposed around the magnet 32 and serves to amplify the up and down vibrations of the magnet 32 by means of its self weight. Further, an outer diameter of the weight 34 is smaller than an inner diameter of the side periphery casing part 10b, so that in a process where the entire magnet part 30 is vibrated up and down, the contact of the magnet part 30 with the side periphery casing part 10b is prevented to ensure the reliability of the sound vibration actuator 100.

The yoke 36 of the magnet part 30 is disposed between the magnet 32 and the weight 34, and serves to form a closed magnetic circuit capable of allowing the magnetic field generated from the magnet 32 to gently flow.

The elastic member 40 is disposed on the top casing part 10c to support the magnet part 30. The elastic member 40 is decreased in diameter as it goes from the outer peripheral to the inner center and protruded downward direction. The inner surface part of the elastic member 40 is fixed to the magnet part 30, and the outer surface thereof is coupled to the top casing part 10c.

The elastic member 40 serves not only to support the magnet part 30, but also to amplify the up and down vibrations of the magnet part 30 by means of the given elasticity thereof. The elastic member 40 can be made of some magnetic materials.

On the other hand, the elastic member 40 may come into contact with the underside casing part 10a, not with the top casing part 10c, so as to support the magnet part 30. In this case, an inner center of the elastic member 40 comes into contact with the magnet part 30, and an outer periphery thereof comes into contact with the underside casing part 10a.

If the elastic member 40 is coupled to the top casing part 10c or the underside casing part 10a by means of welding, it can have a high fixing force so that a desired resonance frequency can be more accurately set.

Next, the weight part 50 is coupled to the top casing part 10c, while being spaced apart from the top casing part 10c by a given distance. In more detail, as shown in FIG. 2B, the weight part 50 includes a first area A1 coming into contact with a center area of the top casing part 10c from which the protrusion 11 protrudes and a second area A2 spaced apart from the entire area of the top casing part 10c except the first area A1 by the given distance. In this case, the center area of the top casing part 10c corresponds to an area where the protrusion 11 is formed to seat the coil part 20 and the elastic member 40 thereonto, and more desirably, it corresponds to a sectional area of a hollow portion of the protrusion 11.

Meanwhile, as shown in (b) of FIG. 2, the first area A1 of the weight part 50 has a shape of a disc, but it is not limited thereto. So as to minimize a contacted area with the top casing part 10c, for example, a center of the first area A1 of the weight part 50 may be empty like a shape of a donut, thereby preventing the vibrations of the top casing part 10c from being inhibited.

Referring to (a) of FIG. 3, a thickness D1 of the first area A1 of the weight part 50 is higher than a thickness D2 of the second area A2 thereof, and next, the weight part 50 is coupled to the top casing part 10c by means of bonding or welding, so that the weight part 50 can be firmly fixed to the top casing part 10c.

Further, the thickness D1 of the first area A1 of the weight part 50 can be varied according to the size of the second area A2 thereof. As the second area A1 becomes large, that is, as a diameter R2 of the second area A2 becomes large, the second area A2 of the weight part 50 can be vibrated together with the top casing part 10c in a process where the top casing part 10c is vibrated, so that the entire area of the weight part 50 except the center area thereof can come into contact with the top casing part 10c. So as to avoid such contact, accordingly, the thickness D1 of the first area A1 can be more increased. As a result, the resonance frequency in a high frequency band of the sound vibration actuator 100 can be controlled by means of the weight part 50, and the vibrations of the top casing part 10c cannot be offset.

In addition, as shown in (b) of FIG. 3, the weight part 50 has a coupling member 70, instead of the protruding portion from the first area A1 that is spaced apart from the top casing part 10c by the given distance. In detail, the weight part 50 includes a shape of a disc having the second area A2 having the second diameter R2, and the coupling member 70 having a given height is bonded to the top casing part 10c, so that the weight part 50 adapted to control the resonance frequency in a high frequency band can be more easily attached to the top casing part 10c. In this case, the coupling member 70 is made of various materials being capable of being formed to the given height like a double-sided tape, and accordingly, no bonding or welding is required, thereby making the manufacturing process simplified.

Referring again to FIG. 2, if the weight part 50 has larger mass than the coil part 20 or the top casing part 10c, a high frequency resonance band generated by the vibration of the coil part 20 can be lower than that when not coupled to the weight part 50.

So as to control the resonance frequency of the coil part 20 by means of the weight part 50, in detail, the weight part 50 is located on top of the top casing part 10c where the vibration effect thereof can be optimized.

Moreover, the weight part 50 is made of a magnetic or non-magnetic material, and if the second area A2 except the first area A1 of the weight part 50 as the center area thereof is made of a magnetic material, it collects the magnetic flux generated from the coil 22 in the same manner as the coil yoke 24 and amplifies the electromagnetic force.

So as to amplify the electromagnetic force and the vibrations, further, a diameter R1 of the weight part 50 can be adjusted, and an adjustment value in the diameter R1 of the weight part 50 can be varied in accordance with the resonance frequency to be controlled by the user. In detail, the diameter R1 of the weight part 50 is larger than an inner diameter R2 of the coil part 20. In more detail, the minimum diameter R1 of the weight part 50 is larger than the inner diameter R2 of the coil part 20, and the larger the diameter R1 of the weight part 50 is, the smaller the value of the resonance frequency is. Accordingly, the diameter R1 of the weight part 50 is adjusted to control an amount of resonance frequency decreased.

Lastly, the sound vibration actuator 100 includes a buffering member 60 adapted to prevent the casing 10 from being damaged due to the vibrations of the weight part 50, the coil part 20 and the magnet part 30 in the internal space thereof. In detail, the buffering member 60 is disposed on the underside casing part 10a to prevent the external sound generator S from being damaged due to vibration impacts or to prevent loss in amount of vibration.

Up to now, an explanation on the internal structure of the sound vibration actuator 100 according to the first and the second embodiments of the present invention has been given. According to the present invention, the sound vibration actuator 100 has the weight part 50 coupled to the outer surface of the top casing part 10c to control easily the resonance band of high frequency, so that the external sound generator S coupled to the sound vibration actuator 100 can generate sounds corresponding to such high frequency band. Accordingly, the sound vibration actuator 100 can be applied to various fields.

Hereinafter, the sound vibration actuators according to the third to fifth embodiments of the present invention will be explained.

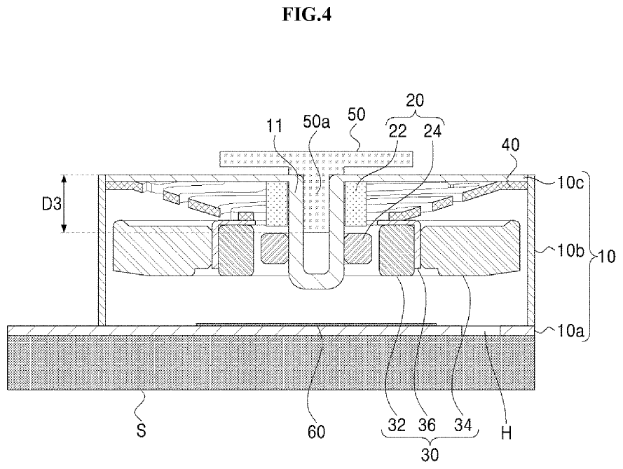

FIG. 4 is a sectional view taken along the line A-A′ of the sound vibration actuator according to the third embodiment of the present invention in FIG. 1.

As shown in FIG. 4, the sound vibration actuator 100 includes a casing 10, a coil part 20, a magnet part 30, an elastic member 40, and a weight part 50. For the brevity of the description, an explanation on the parts having the same configurations and shapes as in the first embodiment of the present invention will be avoided.

The sound vibration actuator 100 according to the third embodiment of the present invention is configured to allow the weight part 50 to be disposed on top of the top casing part 10c in such a manner as to be press-fitted to the top casing part 10c. In detail, the weight part 50 according to the third embodiment of the present invention includes a shaft 50a in addition to the weight part 50 according to the first embodiment of the present invention, thereby controlling the resonance frequency of the sound vibration actuator 100. In this case, the shaft 50a is disposed inside the protrusion 11 having the hollow shape on the top casing part 10c, and the weight part 50 has a shape of a nail, so that it can be firmly coupled to the top casing part 10c by means of press-fitting.

Further, a maximum thickness D3 of the shaft 50a inserted into the protrusion 11 of the top casing part 10c corresponds to a maximum depth of the protrusion 11, and a minimum thickness thereof corresponds to a thickness of the coil 22 fitted to the protrusion 11 of the top casing part 10c, thereby preventing escape of the weight part 50 during the sound vibration actuator 100 is vibrated.

Further, the weight part 50 is made of a material having a higher specific gravity than the coil part 20 constituted of the coil 22 and the coil yoke 24 or the top casing part 10c coupled to the coil part 20, accordingly, a high frequency resonance band generated by the vibration of the coil part 20 can be lower than that when not coupled to the weight part 50.

Meanwhile, the weight part 50 is made of a magnetic or non-magnetic material, and if it is made of a magnetic material, it collects the magnetic flux generated from the coil 22 in the same manner as the coil yoke 24 and amplifies the electromagnetic force.

So as to amplify the electromagnetic force and the vibrations, further, the thickness D3 of the shaft 50a can be varied in accordance with the resonance frequency to be controlled by the user. In detail, the larger the thickness D3 of the shaft 50a is, the larger the mass of the weight part 50, and accordingly, the smaller the value of the resonance frequency is. As a result, the thickness D3 of the shaft 50a is adjusted to control an amount of resonance frequency decreased.

Up to now, the configuration of the weight part 50 in the sound vibration actuator 100 according to the third embodiment of the present invention has been explained. According to the present invention, the weight part 50 is configured to allow the shaft 50a to be formed integrally with the weight part body having a shape of a disc, so that it can be easily coupled to the top casing part 10c by means of only press-fitting using the shaft 50a, thereby providing an excellent coupling force.

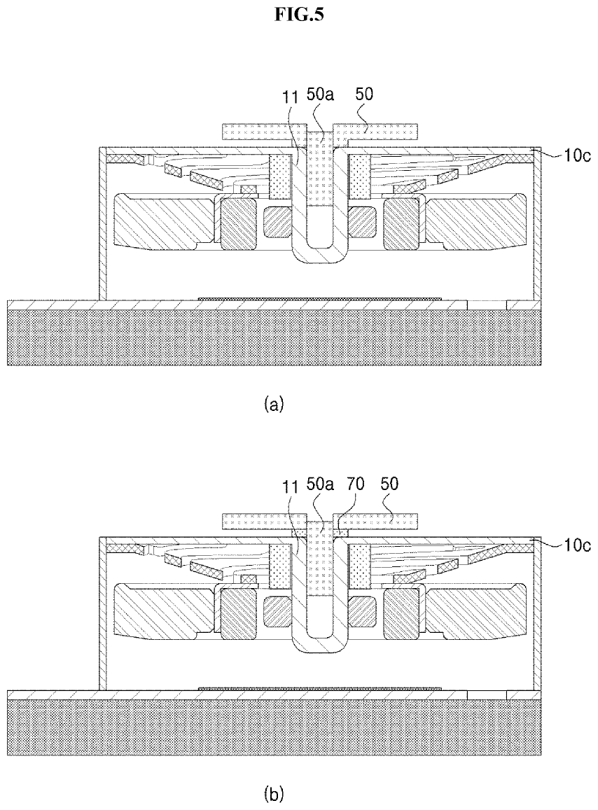

On the other hand, the weight parts 50 in the first to third embodiments of the present invention have an integral body, so that they have excellent coupling forces, but they cause inconvenient manufacturing processes. Hereinafter, configurations of weight parts 50 being capable of more conveniently manufactured will be explained with reference to FIG. 5.

FIG. 5 is sectional views taken along the line A-A′ of the sound vibration actuator according to the fourth and fifth embodiments of the present invention in FIG. 1.

Referring to (a) of FIG. 5, the weight part 50 whose center area is empty to a shape of a ring, so that a shaft 50a can be press-fitted to the center area of the weight part 50 and the hollow portion of the protrusion 11. In detail, the weight part 50 is provided just with the through hole formed on the center portion thereof in such a manner as to correspond to the hollow portion of the protrusion 11, without any integral formation with the shaft 50a, so that it can be coupled to the top casing part 10c.

Referring to (b) of FIG. 5, the weight part 50 includes a shaft 50a and a coupling member 70. In detail, the weight part 50 is penetrated into a center area where the protrusion 11 is disposed, to a shape of a ring, and in the same manner as the weight part 50, also, the coupling member 70 is empty in a center area where the protrusion 11 is disposed, to a shape of a ring. In detail, the weight part 50 just has a shape of a flat ring, without any protrusion having a given height spaced apart from the top casing part 10c by a given distance, so that it can be easily coupled to the top casing part 10c, and since the weight part 50 is not coupled to the top casing part 10c by means of bonding or welding, further, the mass of the weight part 50 can be more easily adjusted to control the resonance frequency.

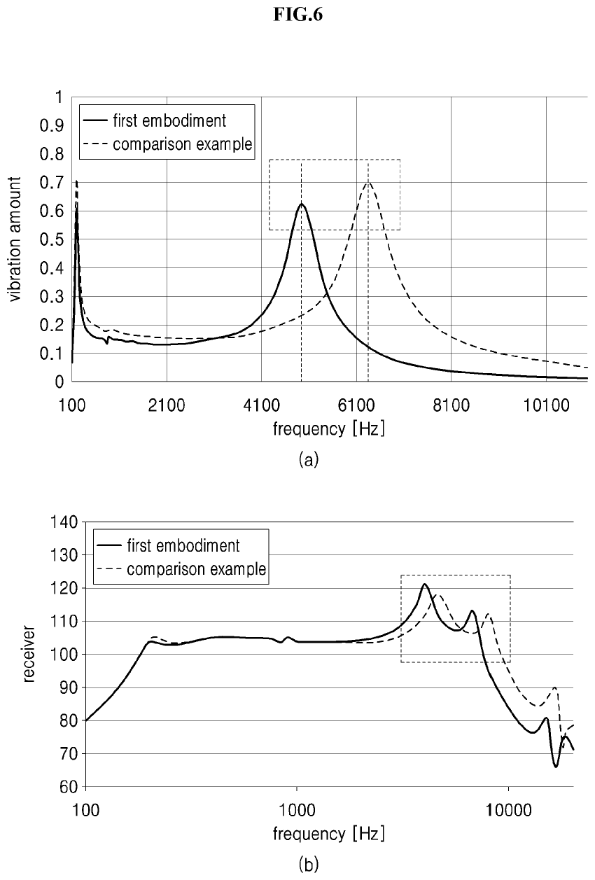

FIG. 6 is graphs showing changes in the characteristics of the sound vibration actuator according to the first embodiment of the present invention.

As shown in (a) of FIG. 6, if the weight part 50 has the shape of the disc according to the first embodiment of the present invention, it can be checked that a high frequency resonance band becomes lower than that in a comparison example wherein the weight part 50 is not mounted. Accordingly, the high frequency resonance band can be lowered up to a minimum 5000 Hz, so that the sound vibration actuator 100 can generate vibrations in a large range of high frequency resonance band.

Referring to (b) of FIG. 6, further, the sound vibration actuator 100 according to the first embodiment of the present invention is fixed to the external sound generator S serving as a receiver, and accordingly, it can be checked that a sound pressure dB in a high frequency band of the sound vibration actuator 100 is increased. If the weight part 50 is mounted in the sound vibration actuator 100, a high sound pressure can be generated even in a relatively low frequency band.

Up to now, an explanation on the configuration of the weight part 50 fixedly coupled to the top casing part 10c of the sound vibration actuator 100 according to the embodiments of the present invention has been given. According to the present invention, the weight part 50 having various shapes is fixed to the top of the top casing part 10c from which a high frequency vibration is generated, thereby controlling the high frequency vibration in a relatively low range, and also, even the external sound generator S mounted on the sound vibration actuator 100 can generate sounds in a large frequency range at the same sound pressure as each other.

As described above, the sound vibration actuator according to the present invention is configured to allow the weight part to be coupled to the part for generating vibrations, thereby controlling vibrations in a high frequency resonance band.

In addition, the sound vibration actuator according to the present invention is configured to have the weight part to be coupled to top of the top casing part for generating vibrations in the casing constituting an outer space thereof in such a manner as to be spaced apart from the top casing part by the given distance, thereby controlling vibrations in a high frequency resonance band, without any inhibition in the vibrations of the top casing part.

In addition, the sound vibration actuator according to the present invention can be varied in coupling ways of the components thereof to generate vibrations in a high frequency band as well as a low frequency band.

In addition, the sound vibration actuator according to the present invention can generate sounds in the range of low to high frequency bands from the external sound generator coupled thereto.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A sound vibration actuator comprising:
a casing (10) having an internal space formed by an underside casing part (10a), a side periphery casing part (10b), and a top casing part (10c);
a coil part (20) coupled to the top casing part (10c) in such a manner as to receive power from the outside;
a magnet part (30) disposed in the internal space of the casing (10);
an elastic member (40) whose one surface coupled to the magnet part (30); and
a weight part (50) coupled to the top casing part (10c).

2. The sound vibration actuator according to claim 1, wherein the weight part (50) is coupled to top of the top casing part (10c).

3. The sound vibration actuator according to claim 1, wherein the underside casing part (10a) is fixed to an external sound generator (S).

4. The sound vibration actuator according to claim 3, wherein the top casing part (10c) has a protrusion (11) protruding from a center thereof.

5. The sound vibration actuator according to claim 4, wherein the protrusion (11) has a hollow shape in such a manner as to protrude inward from top of the top casing part (10c).

6. The sound vibration actuator according to claim 5, wherein the weight part (50) comprises:
a first area coming into contact with a center area of the top casing part (10c) where the protrusion (11) is formed; and
a second area spaced apart from the entire area of the top casing part (10c) except the first area by the given distance.

7. The sound vibration actuator according to claim 6, wherein a thickness of the first area is higher than a thickness of the second area.

8. The sound vibration actuator according to claim 7, wherein the weight part (50) further comprises a shaft (50a) extended from the first area in such a manner as to be disposed inside the protrusion (11) having the hollow shape.

9. The sound vibration actuator according to claim 7, wherein the weight part (50) is penetrated into a center portion thereof in such a manner as to have a shape a ring and further comprises a shaft (50a) insertedly fitted to the center portion thereof.

10. The sound vibration actuator according to claim 1, wherein the weight part (50) is made of a material having a higher specific gravity than the coil part (20) and the top casing part (10c).
